(19) United States
(12) Patent Application Publication
(10) Pub. No.: US 2008/0286074 A1
(43) Pub. Date: Nov. 20, 2008

(54) Inter-Box Connector (Ibc) Storage and Handling System

(75) Inventors: Manivannan Chellappa, Singapore (SG); Ilango K. Kulandavelu, Singapore (SG); Zulkarnain Mohd. Shah, Singapore (SG); Gunasekaran Kanagarajan, Singapore (SG); S. Yogeeswaran, Er., Singapore (SG); Vijayakumar Thulsay, Singapore (SG)

Correspondence Address: INTELLECTUAL PROPERTY / TECHNOLOGY LAW, PO BOX 14329, RESEARCH TRIANGLE PARK, NC, 27709, US

(73) Assignee: SUNROSE TECDESIGN PTE. LTD., (SG)

(21) Appl. No.: 12/064,029

(22) PCT Filed: Aug. 16, 2005
(86) PCT No.: PCT/SG2005/000279

§ 371 Date: Jul. 30, 2008

(51) Int. Cl. B65G 67/60

(52) U.S. Cl. 414/140.3

(57) ABSTRACT

An inter-box connector (IBC) installation and removal system for a freight container having four bottom corner fittings, with each corner fitting being capable of receiving an IBC. The system comprises an IBC handling device having at least one elongated magazine, wherein the magazine has an opening at least one end thereof and being adapted for receiving and supplying IBCs through said opening. The handling device also includes a transport mechanism adapted to move the magazine into IBC receiving and supplying positions such that in each of said positions the opening of the magazine is proximate to one of the respective corner fittings. In addition, the handling device includes at least one IBC installation and removal mechanism arranged and adapted to receive IBCs supplied from the magazine through said opening and to install the same into the respective corner fitting in each of said positions, and to remove the IBCs from the respective corner fittings and supply the same into the magazine through said opening in each of said positions.

The present invention relates to an inter-box connector (IBC) storage and handling (installation and removal) system for a freight container, more specifically, for the storage, installation and removal of IBCs from the respective corner fittings of freight containers. This invention also relates to an IBC supplying and receiving magazine that is used in conjunction with such an IBC storage and handling (installation and removal) system.

About 80% of world trade is carried out by shipping, and a major part of it via freight containers. Each year, about 150 million twenty-foot equivalent unit (or TEUs) freight containers are moved through the seaports of the world. This highlights the necessity for a typical container port to function in an efficient manner. One aspect of achieving said efficiency results from the use of container quay cranes that presently, are capable of loading and unloading a plurality of freight containers in a single cycle.

As container ports become more competitive with respect to each other, said container ports are forced to improve their efficiency in container handling (i.e. the loading and unloading of freight containers to and from a container ship respectively), for example. Accordingly, the implementation of automation in traditionally labour-intensive areas of work, such as the installation and removal of IBCs, for example is one practical way of improving the efficiency of a container port. In tandem with improving the efficiency of the container port, there is also an increasing concern for improving the safety standards in a workplace. This is especially so at a container port where large, heavy lifting equipment is employed and invariably involves the movement of heavy loads over port workers.

With regard to the above-mentioned efforts to improve the efficiency of the container port, U.S. Pat. No. 6,554,557 describes a semi-automatic system for installing and removing inter-box connectors (IBCs). The system described therein includes a pair of conveyors arranged along the longitudinal side of the base of a freight container. The freight container itself sits on a support structure. Each conveyor has carriers formed along the conveyor and each carrier is used for transporting and positioning individual IBCs proximate to the bottom corner fittings of a container. Once the IBCs are in alignment with the corner fitting of the container, the individual IBCs are manually placed into said corner fittings by means of a jacking device. The jacking device allows a user, through the activation of a foot-pedal to push the IBC upward and into said corner fitting. Conversely, to remove the IBC, the foot-pedal is activated so that the jacking post disengages the IBC from the associated corner fitting and is lowered, manually, back into the carrier.

In spite of the above development, there is still a need to increase the efficiency of IBC operations. Specifically, there exists a need for an IBC installation and removal system that is cost effective, efficient and portable. In this regard, an IBC installation and removal system, as defined in the appended claims overcomes the above-mentioned difficulties, in particular those of improving the efficiency of a container port and maintaining suitable safety standards for the workers thereof.

Accordingly, such an inter-box connector (IBC) storage and handling (installation and removal) system for a freight container having four bottom corner fittings, with each corner fitting being capable of receiving an IBC, includes an IBC handling device. The IBC handling device includes at least one elongated magazine. The magazine is fabricated having an opening at least one end thereof and is adapted for receiving and supplying IBCs through said opening. The IBC handling device also includes a transport mechanism adapted to move the magazine into IBC receiving and supplying positions. In each of said positions the opening of the magazine is proximate to one of the respective corner fittings and to at least one IBC installation and removal mechanism. The IBC installation and removal mechanism is arranged and adapted to receive IBCs supplied from the magazine, through said opening, and to install the same into the respective corner fitting in each of said positions. Conversely, during the removal of IBCs, the IBC installation and removal mechanism removes said IBCs from the respective corner fittings and supplies the same into the magazine through said opening in each of said positions. As the system of the present invention automates the installation and removal of IBCs, which is normally carried out by stevedores (manual labour), it can also be referred to as an auto-stevedore system.

In one embodiment, the system may further comprise a support structure for the freight container. The support structure, having a support surface for supporting the freight container, may be dimensioned such that critical portions of the container rests on said supporting surface. Alternatively, the entire container may rest on said support surface of the support structure. The support structure aids in the installation or removal of IBCs into and from said bottom corner fittings respectively in that it provides a means of securing the freight container in a fixed position.

In another embodiment, the above-mentioned IBC handling device may be coupled underneath the support structure. Specifically, the IBC handling device may be situated underneath the support surface of the support structure. In this regard, it follows that the magazines and any corresponding mechanisms, such as the IBC installation and removal mechanisms, for example, may also be located beneath the support surface in the embodiment that includes a support structure.

In a further embodiment, the magazine or the plurality thereof may be horizontally orientated with respect to the support surface of the support structure. In the embodiments where the magazines are horizontally placed, the magazines have an opening at least one end thereof. Alternatively, in another embodiment of the arrangement of magazines, the magazines may be arranged to be vertically orientated with respect to the support surface of the support structure (i.e. perpendicular to the support surface). In this alternative orientation of the magazine, said magazine may also have an opening at least one end thereof.

In an exemplary embodiment of the present invention, the transport mechanism is adapted to move the magazine into four receiving and supplying positions. Of note, the movement of the magazines into the receiving and supplying positions is done in accordance with the orientation and number of openings present in the magazines used. In this regard, as an illustrative example, in the above-mentioned embodiment, wherein the magazine is vertically orientated with at least one open end, the same magazine supplies IBCs to all four corner fittings if the transport mechanism is capable of moving said magazine into four different positions. Accordingly, in another illustrative example, the embodiment wherein the magazine is horizontally orientated with respect to the supporting surface of the support structure, and has two openings at either end thereof, the magazine may supply IBCs to all four corner castings if the transport mechanism is capable of moving the magazine into two different receiving and supplying positions.

In a further embodiment of the horizontally orientated magazines, said horizontally orientated magazine may be formed of two portions. Each portion may have two openings and may be adapted for receiving and supplying IBCs from and to the respective corner fittings of the freight container. In the embodiments where the magazine is orientated horizontally, said magazines may be arranged parallel to the length or width of the base of the freight container.

The transport mechanism, in any of the above-mentioned embodiments is adapted to move the magazine into any of the said receiving and supplying positions by rotational or cyclic motion. In embodiments where the magazine moves via cyclic motion, the transport mechanism may be a cyclic conveyor mechanism capable of moving a plurality of magazines into said receiving and supplying positions by cyclic motion.

In another embodiment, the transport mechanism may be adapted to move the at least one IBC installation and removal mechanism between any of the respective corner fittings of the freight container. In this embodiment, the magazines proximate to the corner fittings may remain stationary. Accordingly, the installation and removal mechanism may be adapted to locate the IBC dispensed from the magazine, and to fit said IBC into the relevant corner fitting. Consequently, the installation and removal mechanism may be expected to perform the same locate and fit function at each of the corner fittings.

In an example of a cyclic conveyor mechanism, a plurality of magazine may be on a track wherein said track is arranged to pass proximate to each corner fitting. Accordingly, the plurality of magazines moves along the track between each IBC receiving and supplying position. In all the embodiments described herein, the IBC handling device may include a plurality of magazines.

In another embodiment, the IBC handling device may include at least two transport mechanisms being arranged in a stack. In this respect, the space beneath any supporting surface present may be adapted to allow for at least two transport mechanisms to be stacked, one atop the other.

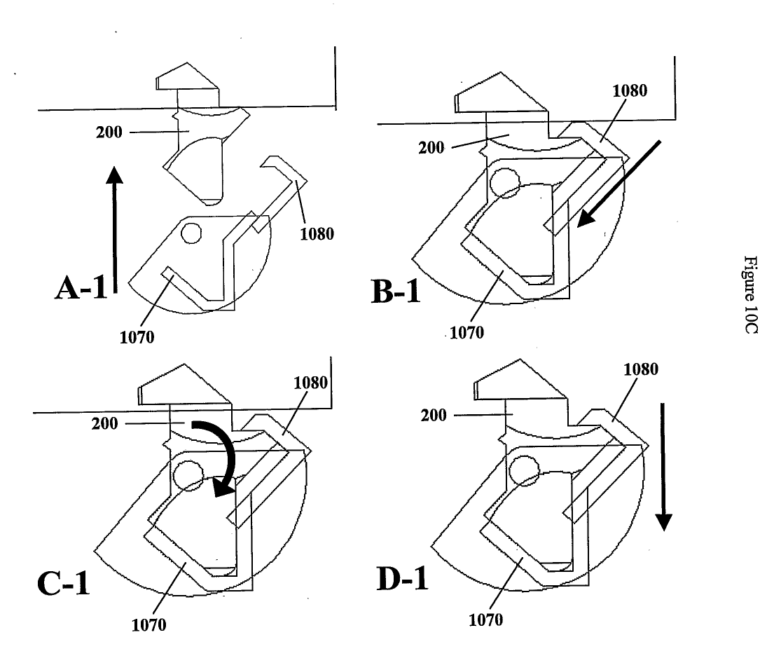

The IBC installation and removal mechanism, in a first embodiment, may be in the form of a lever actuator adapted to grip the dispensed IBC and manipulate it sufficiently to fit said IBC into a corner fitting (cf. FIG. 10A).

In a second embodiment, the IBC installation and removal mechanism may be an (clamping) arm adapted to clasp the IBC and to manipulate it in order to fit said IBC into the corner casting (cf. FIG. 10B). For the first and second embodiments, the manipulation of the IBC (positioning and orientation) may be sufficient to install and remove said IBC.

In a third embodiment of the installation and removal mechanism, the installation and removal mechanism may simply be a lever adapted to engage a catch on the IBC. Once the catch is engaged, the IBC may be simply pushed into or removed from the respective corner casting (cf. FIG. 10C).

In a fourth embodiment of the IBC installation and removal mechanism, the mechanism may be placed within cams or slots such that when actuated, a predefined motion is established (cf. FIG. 10D). The predefined motion manipulates the IBC contained in a clasping portion of said mechanism to enable installation and removal operations.

In a fifth embodiment of the installation and removal mechanism, the magazine itself may be adapted to provide a means of installing and removing the IBC directly to the corner fitting. In this respect, it may be taken that the installation and removal mechanism is integrated along with the magazine and functions in conjunction with the magazine transport mechanism (cf. FIG. 10E).

All embodiments described herein may further include an alignment mechanism (fine alignment mechanism) coupled to the IBC installation and removal mechanism. The IBC installation and removal mechanism alignment mechanism includes, or is in the form of a vertically moveable arm. Such an arm may move vertically as it slides along upright guiding posts. These upright guiding posts may also be coupled to a horizontally moveable frame. At least two of the four edges of the horizontally moveable frame may be coupled to the support structure beneath the support surface via elastic means. The horizontally moveable frame may also have up to four IBC installation and removal mechanisms mounted on said vertically moveable arms such that said IBC installation and removal mechanisms are in alignment with the respective corner fittings. The vertically moveable arms that provide an alignment between the installation and removal mechanism and the respective corner fittings are also located at least two of the four edges of the horizontally moveable frame to effectively engage the freight container.

The vertically moveable arm is translatable between an initial position and a final position. The initial position is such that it allows each of the IBC installation and removal mechanisms attached thereto, to receive and supply IBCs from and to the magazine. The final position allows each of the IBC installation and removal mechanisms to install and remove IBCs into and from the corner fittings respectively. On each of the respective sides of the vertically moveable arm is at least one guiding element that extends vertically upwards. The guiding element is adapted to engage the container by first abutting, and then sliding along the respective walls of the container during motion between said initial and final positions.

In an exemplary embodiment of the invention, the alignment mechanism consisting of the vertically moveable arm has four pairs of guiding elements situated adjacent to the IBC installation and removal mechanism. Each pair of guiding elements extends vertically upwards from each end of the vertically moveable arm. Said pairs of guiding elements are adapted to engage the container by first abutting, and then sliding on the respective walls of the container during motion between said initial and final position.

In any of the embodiments including the above-described alignment mechanism, the elastic means used to couple said frame to the support structure includes, but is not limited to, a compression/torsion spring, a cantilever or a monolithic flexural spring. Any one or a combination thereof may be used to suitably bias the frame to remain centralized with respect to the support structure.

It should be noted that the transfer mechanism that operationally links the respective corner fittings to the receiving/supplying and storing magazines, in one instance, is embodied as described above, through the vertical movement of the IBC installation and removal mechanism that is mounted on the guiding elements of the fine alignment mechanism. However, it is by no means limited to such predefined movements. In an alternative exemplary embodiment, during loading or unloading operations, the installation and removal mechanism may be adapted to pick a particular magazine from an array of magazines from which it may supply/receive and store IBCs. Accordingly, it follows that a sufficiently flexible installation and removal mechanism is capable of picking a magazine from an array of magazines, to deposit or retrieve IBCs.

In the embodiments of the invention having a plurality (two or more) of magazines, at least one of the magazines may be adapted to store a first variant of IBC and at least one other magazine, within said plurality, may be adapted to store a second variant of IBC. Accordingly, more than two variants of IBCs may also be stored in various magazines according to operating requirements. Examples of IBCs that may be used include, but are not limited to, a twistlock T-1 IBC, a twistlock T-2.3 IBC and a fully automatic T-4 IBC.

The support surface, as mentioned above, is for supporting the freight container during IBC installation and removal operations. In this regard, it may not be necessary for the entire bottom surface of the container to sit on said surface. It may be possible to support the entire freight container provided sufficient portions of the said container are supported during IBC operations.

Alternatively, the entire freight container may be supported by said support structure. Accordingly, the support structure has to be dimensioned to correspond to the bottom dimensions of the freight container (either a 20 foot or a 40 foot container). In the embodiment wherein the entire container is supported by said support structure, the support structure includes an incline plane along at least two orthogonal dimensions of the support surface.

In an exemplary embodiment, the support surface, as mentioned above, may include the incline plane along three or four orthogonal dimensions corresponding to the bottom of the freight container. For the embodiment having two twenty-foot IBC installation and removal devices in tandem (to accommodate a forty-foot container) there may be included a central inclined plane that is spring-loaded and mounted onto the support frame. In this regard, the spring-loaded inclined plane may be compressed when abutted by a forty-foot container placed onto said tandem arrangement.

The IBC handling system of the invention may further include an IBC transfer means. Said IBC transfer means may have a piston and a ram. Both the piston and the ram are adapted to engage the magazine such that said piston and ram are slidable along the longitudinal axis of the magazine either towards or away from the corner fitting when said magazine is in the receiving and supplying position.

In an alternative embodiment, the IBC may be dispensed from the magazine by means of a vibration motor (vibro-motor). In the embodiment having a vibro-motor the magazine, aided by gravity, constantly vibrates such that the IBCs therein are also constantly being moved to the dispensing opening of the said magazine. Conversely, during IBC removal operations, the magazine tilt may be redirected such that gravitational tendencies are rearranged or reversed such that the IBCs are moved into the magazine with the help of said vibration. The embodiment having a vibro-motor may necessitate having a magazine that is inclined at an angle in order to facilitate the movement of IBCs into or out of the magazine.

The piston acts to dispense (supply) the IBC during IBC installation operations. It does so by pushing out each individual IBC for the installation and removal mechanism to grasp. Subsequently, during removal operations, the ram acts to facilitate the retrieval of IBCs. The IBC installation and removal mechanism places the IBC in an intermediate position after disengaging said IBC from the corner fitting. The ram then pushes the IBC back into the magazine for storage till further use.

The moveable components of the IBC handling device, such as the IBC installation and removal mechanism or the transport mechanism, for example, may be actuated by hydraulic means, pneumatic means, electromechanical means or any combination of the aforementioned means. In utilizing pneumatic or hydraulic means, suitable pressure gauges may also be included to ensure the safety and efficiency of the (entire) operating system.

In another embodiment, the handling of an IBC may be (entirely or at least partially) by magnetic means. In this regard, magnetic means typically refers to an electromagnetic source being used to manipulate the orientation of the IBC prior to installation into the respective corner fittings, for example. The magnetic means may be used in conjunction with the IBC installation and removal mechanism. In this regard, the portion of the mechanism that contacts the IBC may be magnetized such that said mechanism merely contacts the IBC, lifts it into position and installs the IBC with minimum friction and manipulation. Conversely, the same may apply during the IBC removal process wherein the mechanism retrieves the IBC from the respective corner fittings through magnetic contact.

Further, the magnetic handling means may be employed to draw an IBC from or deposit an IBC into the magazine.

Alternatively, the magnetic handling means may be used simply for alignment purposes between the IBC and the corner fitting of the freight container. In another exemplary embodiment, the magnetic handling means may also be used to directly translate the IBC from the magazine into the corner fitting.

The system for the installation and removal of inter-box connectors (IBCs) for a freight container can be adapted to accommodate any kind of commercially available freight container which utilizes said IBCs for transportation purposes. In this regard, a forty-foot long freight container or two twenty-foot containers may be accommodated by the IBC handling system, for example. For handling either a forty-foot container or a twenty-foot container, two IBC installation and removal systems can be arranged in a collinear relationship and in abutment to each other. Since each individual system is, by default capable of handling a twenty-foot container the above arrangement provides for the same to be applied to the forty-foot range of containers as well. In this regard, to aid in the abutment of two IBC systems, a locking mechanism may be included among the abutment edge or surface to provide for a secure joining of the two sections.

Alternatively, the IBC installation and removal systems may be placed in tandem or in a line abreast arrangement. This arrangement is in line with the new generation of quay cranes that are capable of lifting a plurality (two or more) of freight container in a single lift. Accordingly, more than one container may be deposited for IBC installation and removal operations. In this respect, the modular system described herein allows for a flexible layout to accommodate both twenty foot and forty-foot freight containers.

The entire system for the removal and installation of IBCs, and their respective embodiments, may be used within the framework of a larger port container management system. In this system, the quay crane and the inter-box connector (IBC) installation and removal system for the freight container are working together and since the need for manual labour is reduced by the IBC system, said IBC system forms a crucial part of the port operations relating to the installation and removal of IBCs.

The IBC handling device as used in the overall container management system may include at least one elongated magazine, wherein the magazine has an opening at, at least one end thereof and is adapted for receiving and supplying IBCs through said opening. In addition, the IBC handling device may also include a transport mechanism adapted to move the magazine into IBC receiving and supplying positions. At each of said positions, the opening of the magazine is proximate to one of the respective corner fittings. Such an arrangement, as described above, allows at least one IBC installation and removal mechanism that is arranged and adapted to receive IBCs supplied from the magazine through said opening, to install the same into the respective corner fitting in each of said positions. Accordingly, the said IBC installation and removal mechanism may also remove the IBCs from the respective corner fittings and supply the same back into the magazine through said opening in each of said positions.

In all the IBC handling system as described herein, an IBC magazine is utilized. The IBC magazine utilized includes an elongated hollow shaft having an opening at least one end thereof. The hollow shaft is adapted for receiving and supplying IBCs through said opening. In this regard, the interior of the shaft may have notches or sliding rails and slots, for example, to accommodate different variants of IBCs.

The IBCs may move within the magazine in a slidable manner. The mechanism dispensing the IBCs, for example may be the afore mentioned ram and piston mechanical mechanism, a spring-loaded mechanism or a chain link adapted to pull out the respective IBCs from the magazine, for example.

In a further embodiment, the IBC magazine is adapted to move between IBC receiving and supplying positions by a transport mechanism. In each of the receiving and supplying positions, the opening of the magazine is proximate to one of the respective corner fittings in order to facilitate the movement of IBCs from the magazine to the IBC installation and removal mechanism or vice versa. In this regard, it may be considered that the IBC magazine is adapted to supply and receive IBCs during the installation and removal of IBCs from the respective corner fittings.

In all the above-mentioned embodiments, the magazine is translatable between supplying and receiving positions with the IBC installation and removal mechanisms being located at said supplying and receiving positions. However, it may also be the case that magazines may remain fixed at the supplying and receiving positions. In such an exemplary embodiment, the installation and removal mechanism may be moved instead to the respective receiving and supplying positions to carry out the installation and removal of the IBCs as required. Accordingly, the above-mentioned kinematic reversal embodiment still retains the principle invention in the other exemplary embodiments described herein.

To aid in the further understanding of the present invention, said invention will be further illustrated by way of non-limiting embodiments, along with an accompanying detailed description of said embodiments.

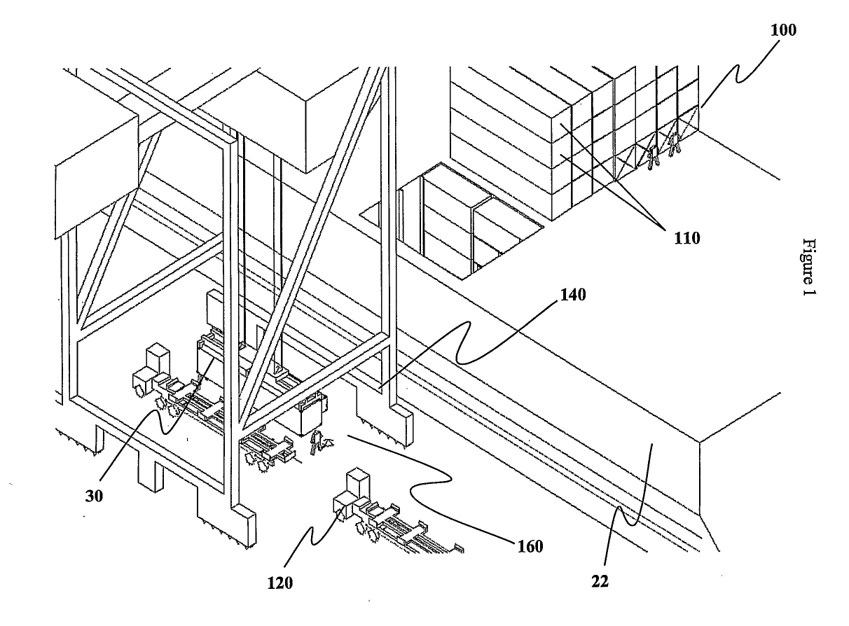

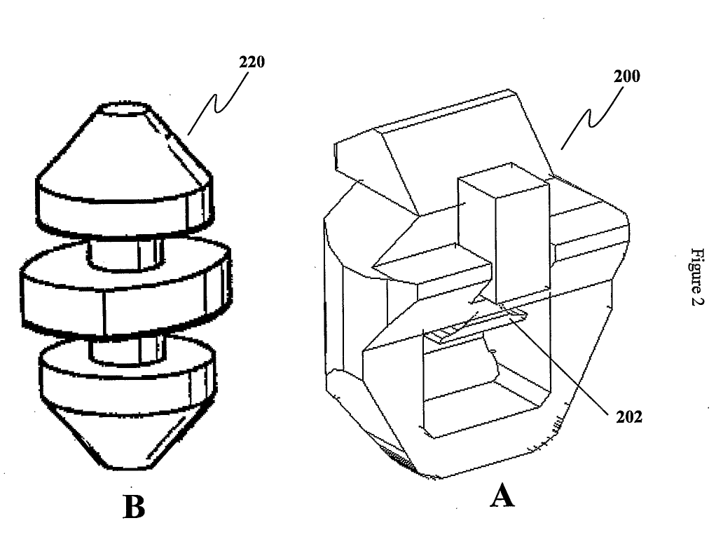

FIG. 1 illustrates a layout of a part of a quay crane operational area of a typical container port;

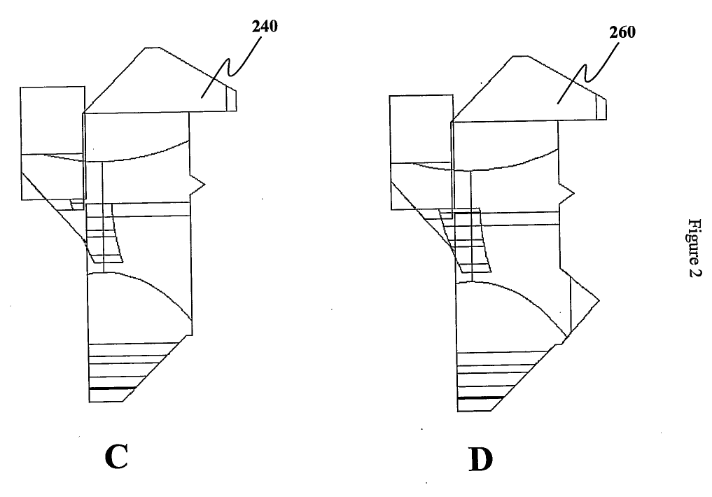

FIGS. 2A and 2B show known IBCs that are commonly used, FIG. 2C shows an IBC that employs T-4 type lever lock and release mechanism and a bottom cone profile suitable for under deck container stacking and FIG. 2D shows a side view of the IBC shown in FIG. 2A;

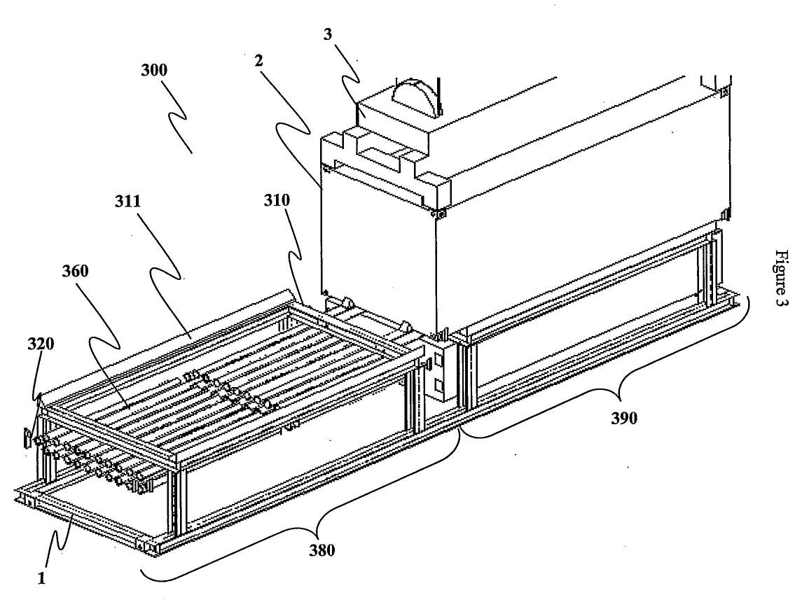

FIG. 3 illustrates an embodiment of the IBC installation and removal system;

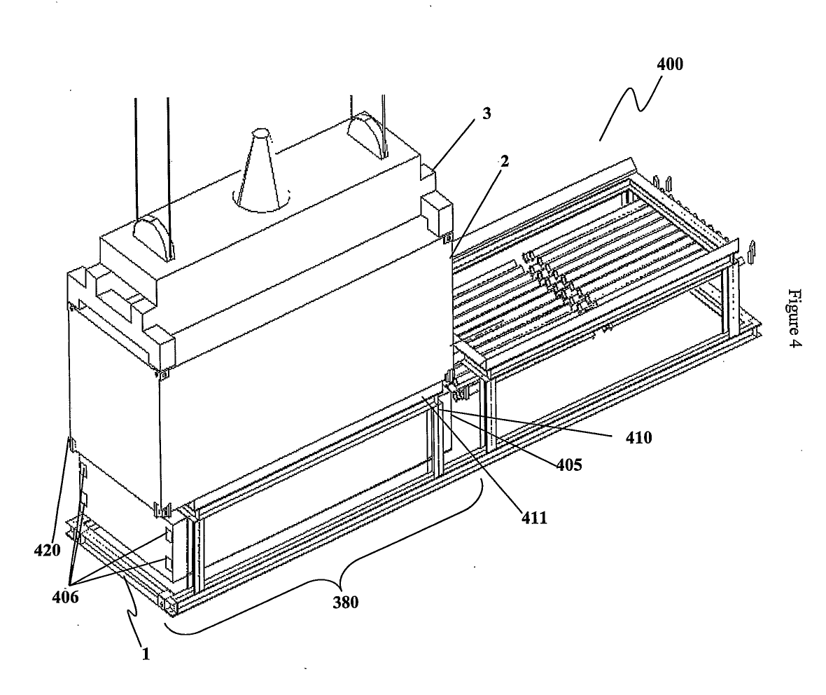

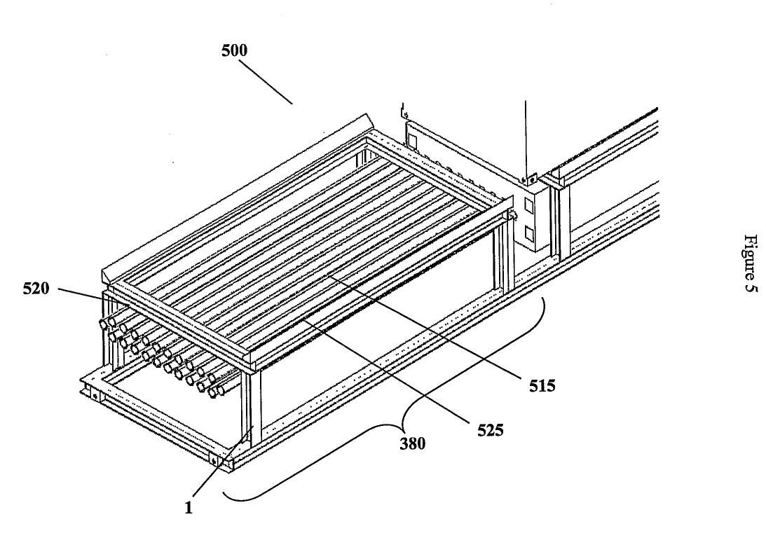

FIG. 4 illustrates an embodiment of the invention wherein two IBC installation and removal systems are arranged in a collinear relationship;

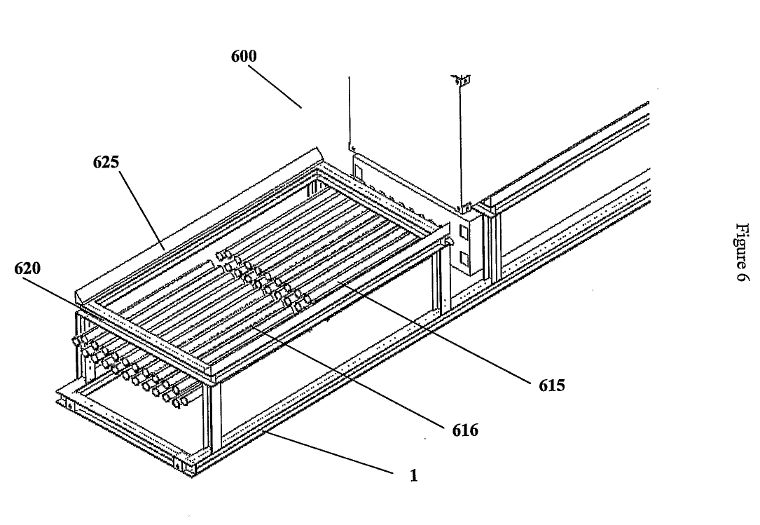

FIG. 5 shows an embodiment of an arrangement of magazines in the IBC handling device;

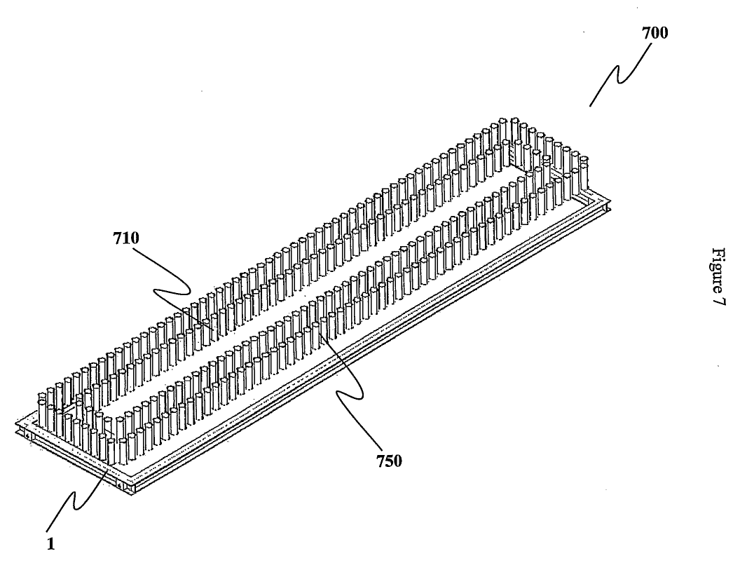

FIG. 6 shows a further embodiment of an arrangement of magazines in an IBC handling device;

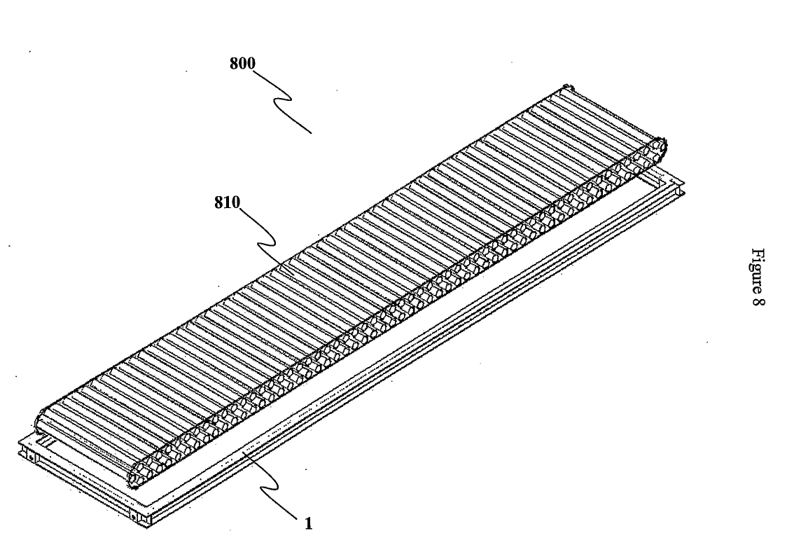

FIG. 7 shows another embodiment of a vertical arrangement of magazines in an IBC handling device;

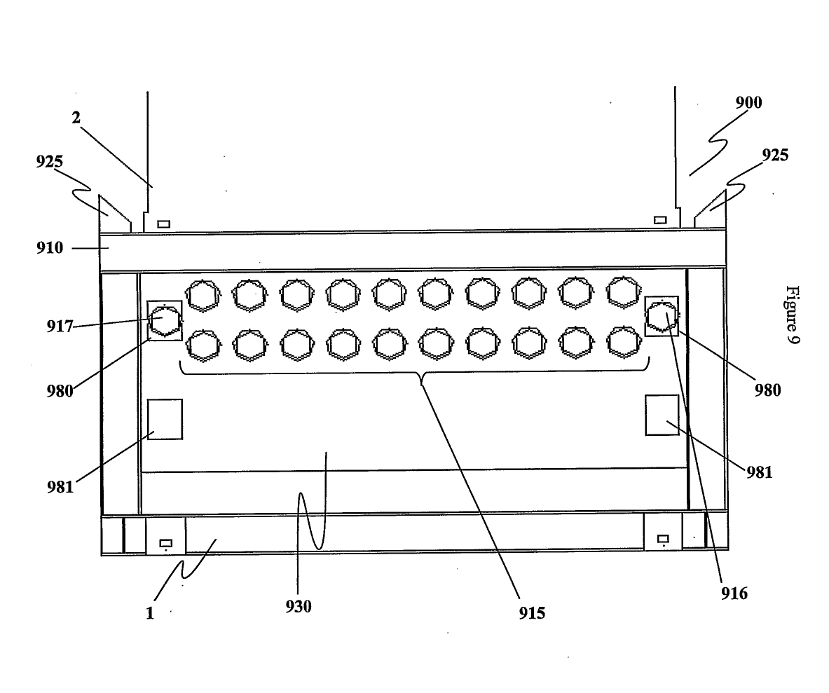

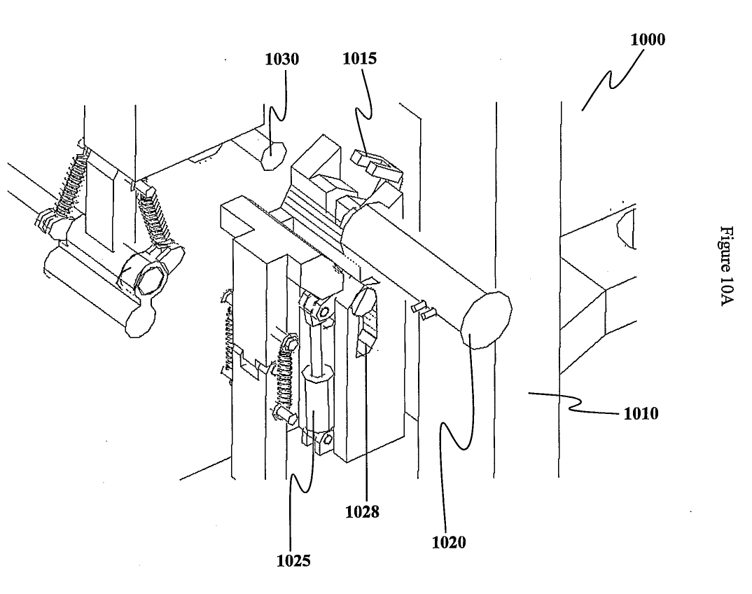

FIG. 8 illustrates an embodiment of an arrangement of magazines across the width of the IBC installation and removal system;

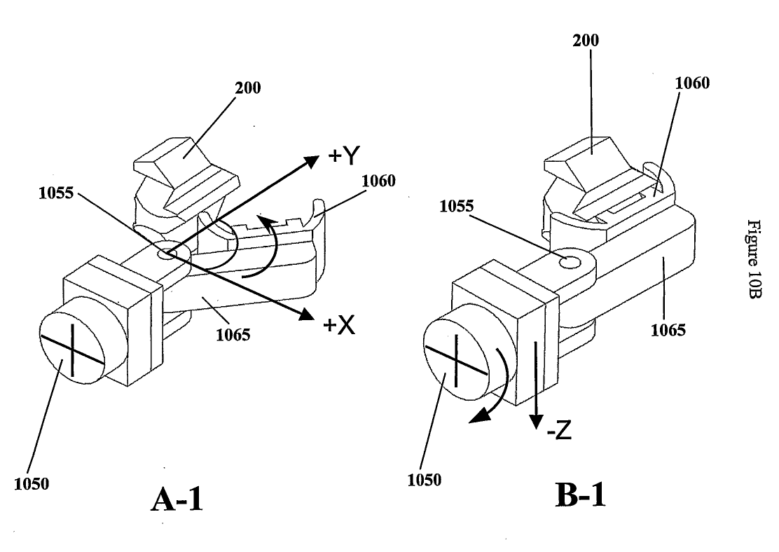

FIG. 9 is a frontal view of the embodiment of FIGS. 3-6;

FIGS. 10A-10F are illustrations of IBC installation and removal mechanisms;

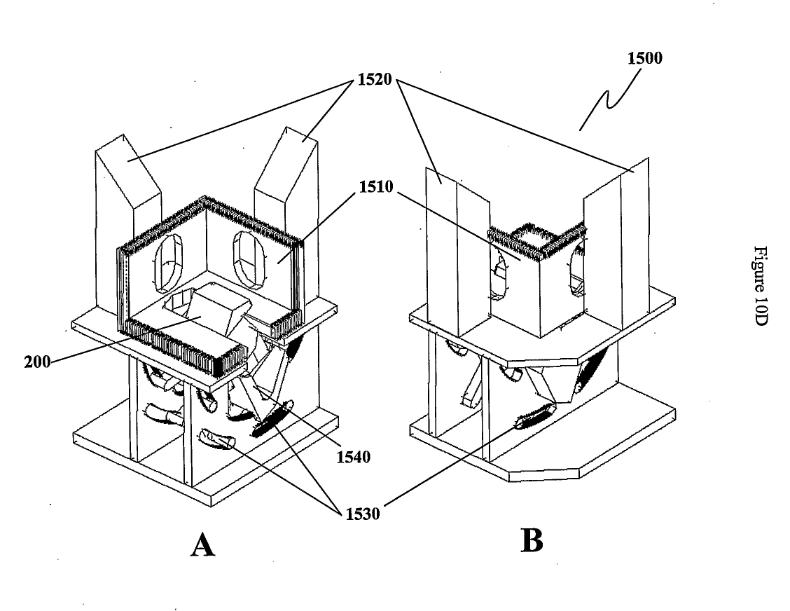

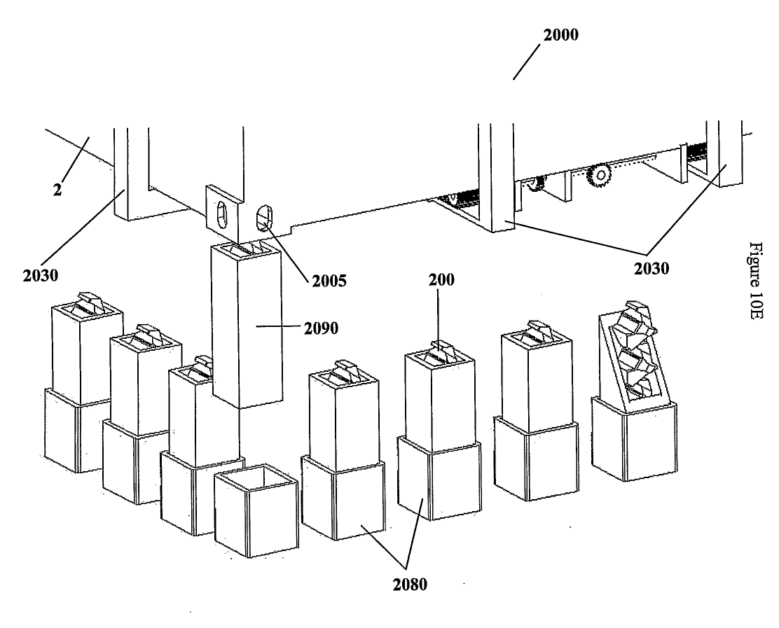

FIG. 11 illustrates an embodiment of a fine alignment mechanism;

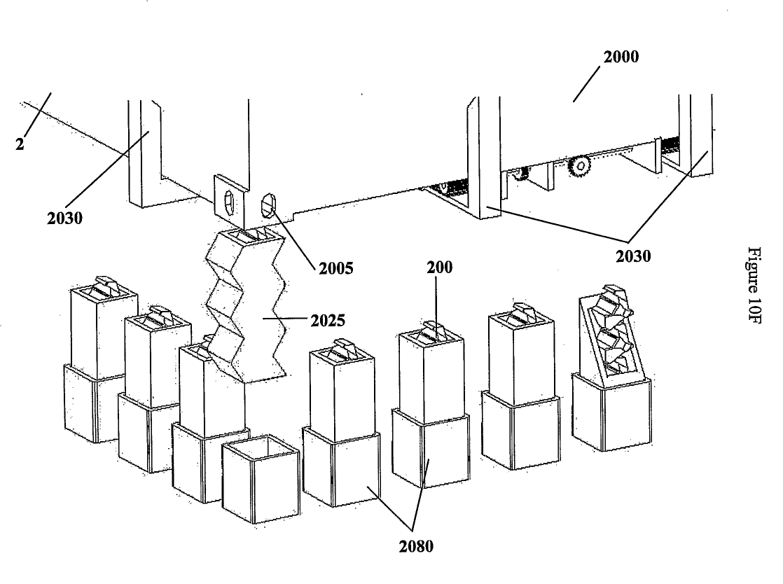

FIG. 12 illustrates a plurality of magazines and an arrangement of IBCs therein in relation to the fine alignment mechanism;

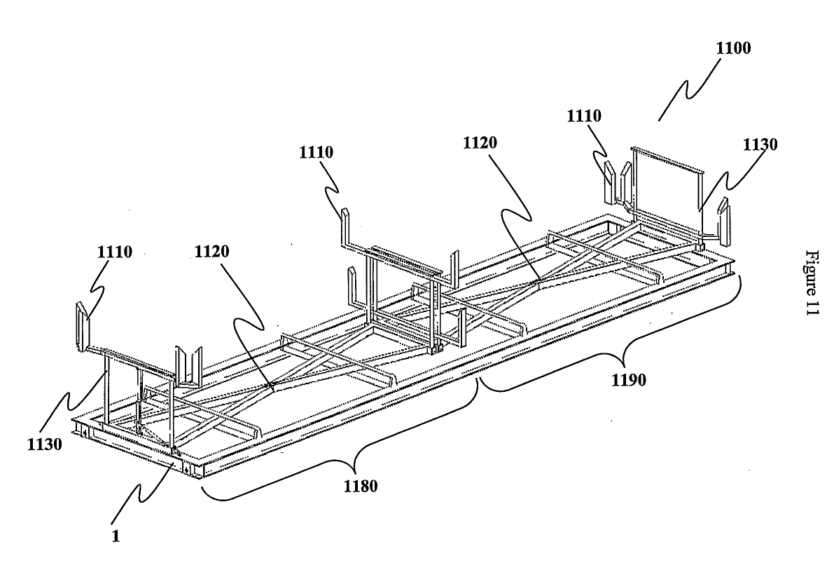

FIGS. 13A and 13B show an enlargement of a fine alignment mechanism when engaged with a container;

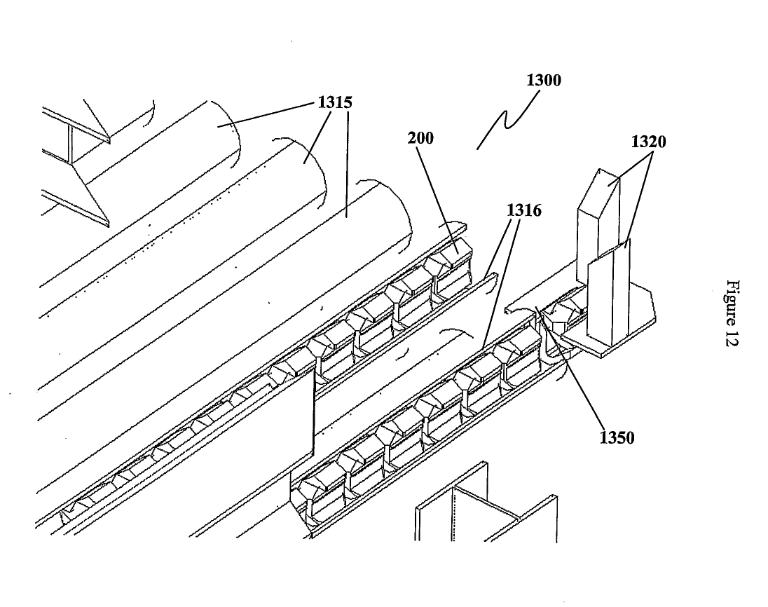

FIG. 14A and FIG. 14B illustrates an alternative embodiment of a fine alignment mechanism;

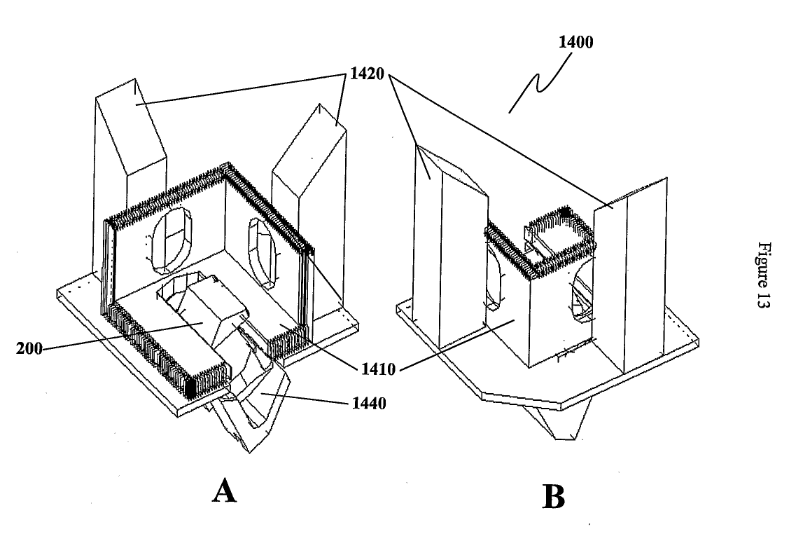

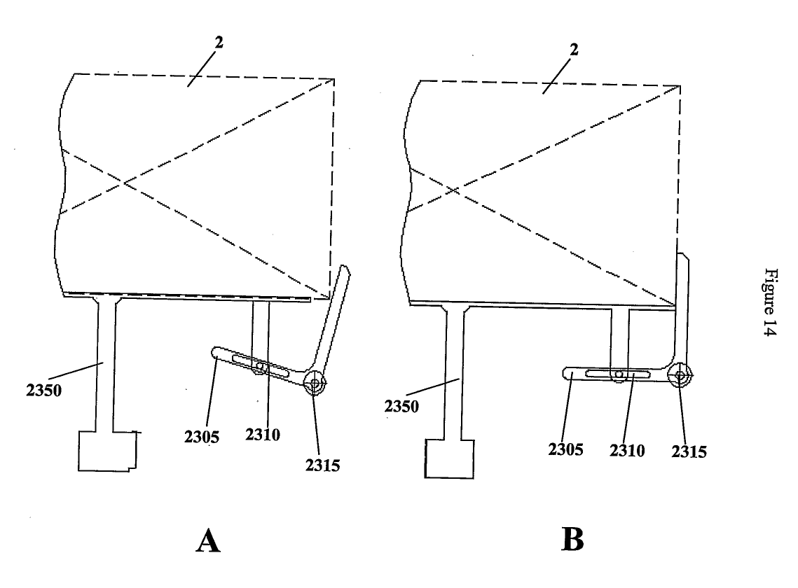

FIG. 15 is an isometric drawing of a further embodiment of the IBC storage and handling system;

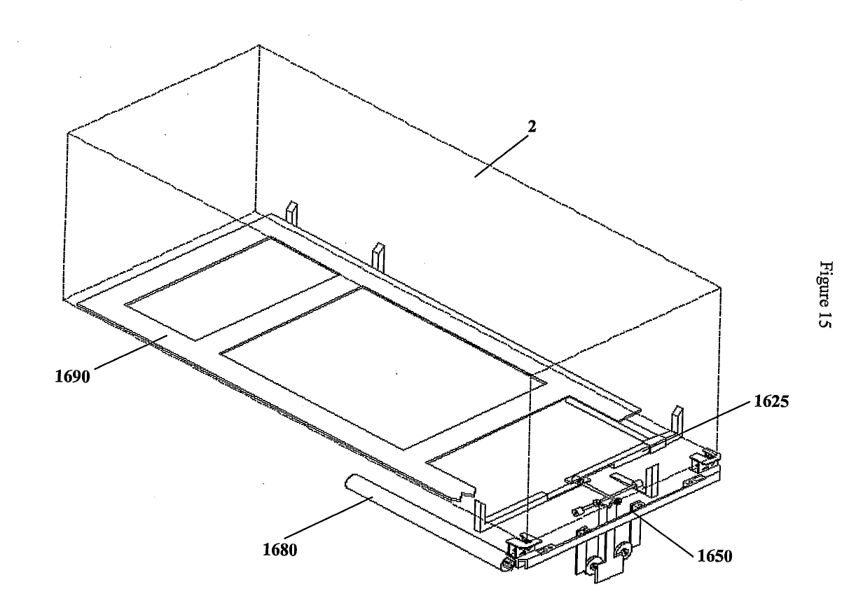

FIG. 16 illustrates an alternative embodiment of a fine alignment mechanism and IBC installation and removal mechanism;

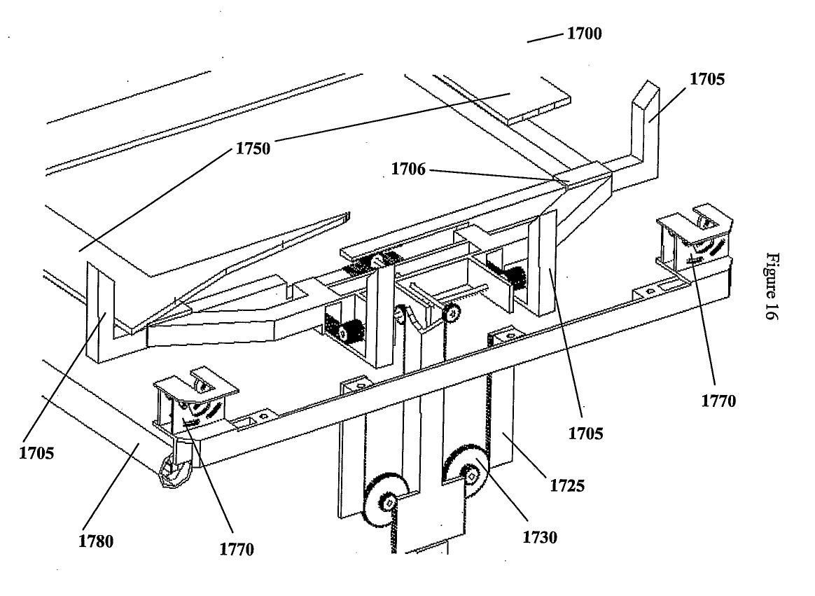

FIG. 17 illustrates the coupling of a fine alignment mechanism to a IBC installation and removal mechanism of FIG. 15;

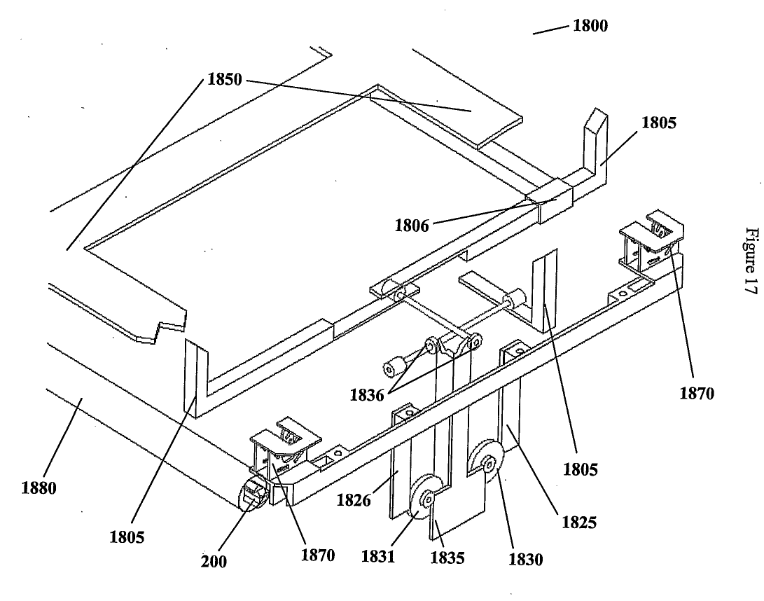

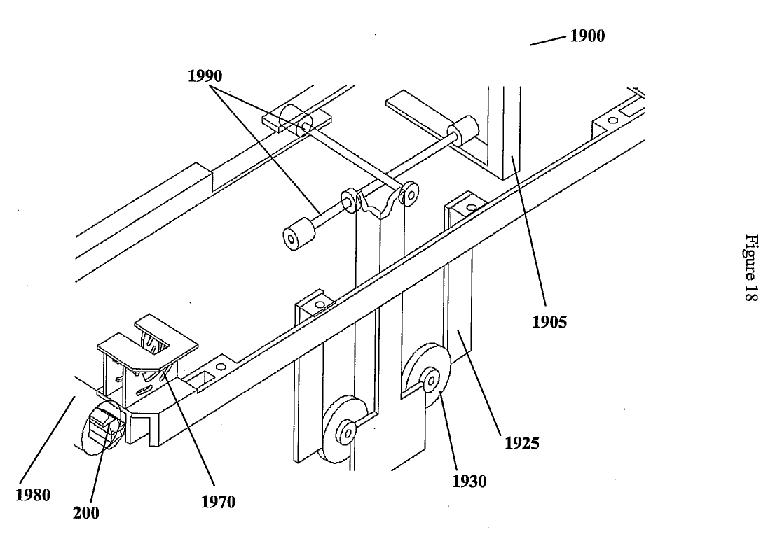

FIG. 18 further illustrates the IBC installation and removal mechanism of FIG. 15;

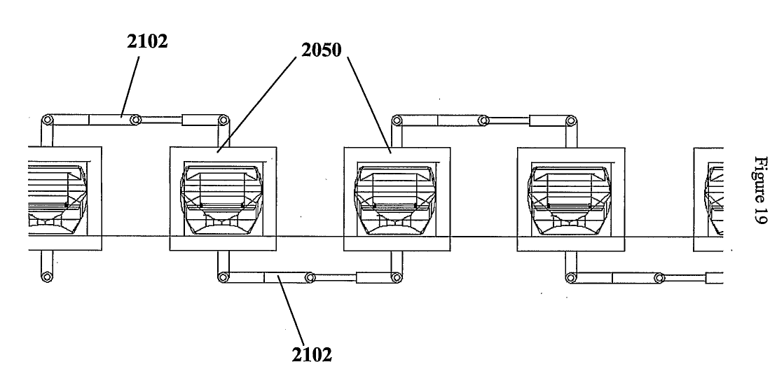

FIG. 19 illustrates an embodiment by which the magazines are linked when placed in a vertical orientation as shown in FIG. 10E;

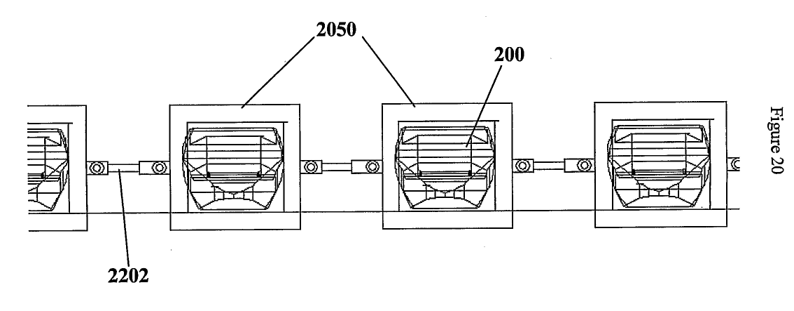

FIG. 20 shows a further embodiment by which the magazines are linked when placed in a vertical orientation as shown in FIG. 10E; and

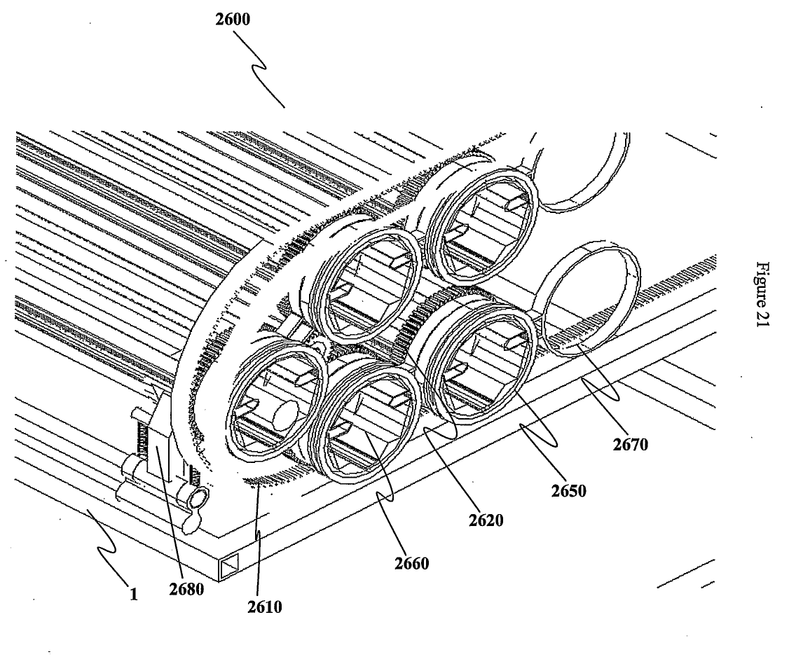

FIG. 21 shows an embodiment of a magazine drive mechanism for the magazine transport mechanism.

FIG. 1 illustrates a typical IBC operational area 160 around a standard quay crane 140. As shown in FIG. 1, the quay crane 140 includes a spreader 30 and is operated parallel to the water edge at the quayside. The quay crane 140 serves a loading or unloading bay. Each bay is associated with a set of containers 100 (wherein the individual containers are indicated with reference sign 110) arranged on board the container ship 22 that is within the transverse reach of the quay crane. Within the operational area 160, specific lanes for trailers 120 are marked out in order that said trailer 120 may park beneath the quay crane 140 for loading or unloading operations.

The spreader 30 is extendable in its length to correspond with the length of a container 100 to be picked up. In unloading operations, the container 100 is hoisted from the ship by the quay crane 140, via the spreader 30. The quay crane 140 then moves the container being lifted to the IBC operational area 160. Presently, the container is then lowered to the shoulder height of a stevedore so that the stevedore can remove the IBCs located inside the bottom corner fittings of the container 100. The container is subsequently hoisted onto a trailer 120 for transfer away from the quayside to a storage yard, for example.

For loading operations, a container 100 is brought on a trailer 120 and said trailer 120 parks beneath the quay crane 140 in the IBC operational area 160. The spreader 30 lifts the crane, again to man height in order for the port workers to install IBCs to the four respective corner fittings of the freight container 100. Subsequently, the spreader 30 lifts the container 100 onto the deck (or into the hold) of the container ship 22 where said containers are stacked to a regulation height.

FIGS. 2A and 2B are illustrations of two IBC variants that are currently in use. FIG. 2A is a fully automatic lock T-4 200 (commercially available from German Lashing Robert Böck GMBH, www.germanlashing.de, for example) for use with International Standards Organization (ISO) containers. The T-4 200 includes a lever 202 that acts to fit or release the T-4 from the respective corner fitting that it is secured to. In other words, when the lever 202 is pulled down, the T-4 may be placed into a corner fitting or removed respectively.

The fully automatic locking mechanism of the T-4 200 is only appreciated during the unloading process. In conventional or semi-automatic locking mechanisms of IBCs, further human intervention is required to release the locks between stacked containers prior to said containers being lifted by the crane and subsequently having the IBCs manually removed from said containers. In the case of the T-4 200, the crane operator merely has to shift the container to be unloaded by a horizontal distance of 13 mm. The horizontal shift allows the T-4 200 to disengage from the container beneath for unloading onto the dock for the stevedore to manually remove the IBCs from the respective corner fittings of the container.

FIG. 2B is another variant of IBC known as the Twistlock T-1 220 (also commercially available from German Lashing Robert Böck GMBH, www.germanlashing.de, for example). The T-1 220 serves the same purpose as the T-4 200 in that it too secures containers that are arranged in a stack. However, the T-1 220 is not considered to be a fully automatic lock but rather, a semi-automatic one at best. Unlike the above-mentioned T-4 200, the T-1 220 requires a lever (not shown) to be disengaged manually prior to being lifted by the crane to the dock where the stevedore manually removes the IBCs from the respective corner fittings of the container.

FIG. 2C 240 shows an IBC that employs the same lever mechanism as the T4 of FIG. 2A or 2D but with a modified bottom cone that is suitable for use in the under deck container hold. The difference between an IBC used for under deck stacking and that as used for on deck stacking is clear when FIG. 2C 240 and FIG. 2D 260 are compared. In this regard, the IBC of FIG. 2C is not adapted to grip another container.

FIG. 3 is an illustration of an embodiment 300 of the IBC handling system. The embodiment is shown having a support frame 310 that is capable of supporting one forty-foot container or up to two twenty foot containers 2 in a collinear arrangement. The first container 2 (shown as a twenty-foot container in FIG. 3) may be placed on the section 390, as shown and the second container (not shown) may be placed on section 380. The containers are placed upon the support frame 310 by means of a quay crane spreader 3. The support frame 310 further includes a base 1 that is placed on the ground. The top peripheral edge of the support frame 310 has guiding rails 311 situated along at least two or three of the four edges of said support frame 310. The guiding rails on the short edges of the support frame are not shown. Also shown in the present illustration is a fine alignment mechanism 320 that aids in the installation and removal of the IBCs, the details of which will be elaborated on later.

Beneath the supporting frame 310, a plurality of magazines 360 are arranged such that they are proximate to the corner fittings of the freight container 2 when said container 2 is placed on the support frame 310. The magazines are engaged by a drive mechanism (not shown) to be moveable between IBC receiving or supplying positions. An IBC receiving or supplying position is one where an IBC may be dispensed or received during the installation and removal processes respectively. Each of the plurality of magazines stores a plurality of IBCs.

Section 390 shows freight container 2 placed on top of the support frame 310. The container 2 is initially engaged by the guiding rails 311 that provide a course alignment to the container with respect to the entire IBC installation and removal system. Once placed firmly on the supporting frame 310, the fine alignment mechanism 320 engages the bottom corners of the container to align four IBC installation and removal mechanisms (not shown) to the corner fittings of the freight container. The engagement of the container via the fine alignment mechanism 320 occurs when the fine alignment mechanism 320 translates vertically upward. During said vertical translation the arms of the fine alignment mechanism abut the respective walls of the container. Specifically, as shown in the present illustration, the arms abut the portion of the walls that form the corner of the container.

The IBC installation and removal mechanisms (not shown in FIG. 3) are coupled with the vertically moveable fine alignment mechanism. As such, said IBC installation and removal mechanisms are aligned to the respective corner fittings of the freight container once the sliding along the container walls by the guiding arms begins. When the fine alignment mechanism is translated upwards, the installation and removal mechanisms may simultaneously engage the corner fittings to install or remove the IBCs. Conversely, the installation or removal sequence may be a two-step process in that the alignment of the IBC installation and removal mechanisms takes place first followed by an actuation of the said IBC installation and removal mechanisms to install or remove said IBCs.

FIG. 4 shows the portion 380 having the twenty-foot freight container placed on said support frame 410. Accordingly, as also mentioned above, in place of two freight containers placed in a collinear relationship, the embodiments may also support a single forty-foot freight container.

The fine alignment mechanism 420 is shown to be in an engaged state with the respective corner fittings of the container. In this embodiment, the plurality of magazines is stored within an enclosure 405. The enclosure 405 includes four openings 406 on either latitudinal surface of the enclosure 405. The arrangement of each opening is such that they are in substantial alignment with the corner fittings.

The installation process in the embodiment of FIG. 4 is similar to that as described in FIG. 3.

FIG. 5 illustrates a further embodiment 500 of the present invention. The section 380 is of sufficient dimension to support a twenty-foot freight container. Section 380 may be taken to be the support frame upon which the freight container is placed by the quay crane spreader. The support frame 520 of the section 380 includes guiding rails 525. The guiding rails 525 aid in the alignment of the freight container with respect to the section 380 and may be found along the periphery of the support frame 520. Beneath the support frame 520, each magazine 575 is formed as a single longitudinal piece that extends along the length of the entire supporting frame.

FIG. 6 illustrates another embodiment of the invention wherein the magazines are separated into two portions, the first portion being 615 and the second portion being 616. The first and second portions 615 and 616 are arranged in the similar conveyor system as in the embodiment of FIG. 5. In this instance, two independent drive systems are present to create the cyclic motion of the plurality of magazines as they are moved between the receiving/dispensing and storing positions. As with the previous embodiments, the support frame 620 includes a set of guiding rails 625. The guiding rails 625 are located on three of the four peripheral edges of the supporting frame 620. The guiding rails 625 function to provide course alignment to the freight container to the IBC installation and removal system such that the corner fittings of the container are proximate to the portions 615 and 616. In particular, the corner fittings are in substantial vertical alignment with outward facing portions of the plurality of magazines.

FIG. 7 illustrates another embodiment 700 of the invention wherein the magazines 710 and 750 are vertically arranged with respect to the supporting frame (not shown). As in FIG. 6, the magazines are separated into two portions, the first portion being 710 and the second portion being 750. The first and second portions 710 and 750 are arranged to be in a conveyor system that translates each magazine in either a clockwise or anti-clockwise manner around the periphery of the base 1 of the magazine. As in the embodiment of FIG. 6, two drive systems are required to create the cyclic motion of the plurality of magazines as they are moved between the receiving/dispensing and storing positions.

Unlike FIG. 6, where magazine openings can go proximate to corner fittings, the first portion 710 cannot go directly below corner fittings. In this regard, a linear channel (or conveyor or mechanism that is not shown) that connects the first portion 710, the second portion 750 and the IBC installation and removal mechanism (not shown) in vertical alignment below the corner fitting may function as an intermediary between magazine openings and the respective corner fittings. Such an intermediary may also remove the need for magazines to move relative to the base.

FIG. 8 illustrates another embodiment of the invention wherein the magazines 810 are horizontally arranged with respect to the supporting frame (not shown). As in the embodiment of FIG. 5, the magazines are maintained in a single portion 810. The single portion 810 is arranged to be in a conveyor system that translates each magazine in either a clockwise or anti-clockwise manner between two receiving/supplying and storing positions. As in the embodiment of FIG. 6, a drive system is required to create the cyclic motion of the plurality of magazines as they move between the said two receiving/supplying and storing positions.

FIG. 9 is a side view 900 of the embodiment of FIGS. 3, 4, 5 and 6. The magazines 916 and 917 are in the dispensing or receiving position, in the case of the installation or removal of IBCs respectively. The IBC installation and removal mechanism (not shown) either receives or supplies IBCs from or to the magazines 916 and 917 while said magazines 916 and 917 are in the respective dispensing or receiving positions. In a further embodiment, the same magazine may be used to dispense IBCs at either dispensing position shown. It is to be understood, that depending upon the arrangement of magazines, as shown in the previous embodiments of FIGS. 3-8, at least one magazine is capable of translating between the respective dispensing and receiving positions to provide/receive IBCs to and from the respective corner fittings.

The guiding rails 925 are shown as not abutting the container but may do so when said container is being lowered to the supporting frame 910. Said guiding rails 925 are inclined inwards such that when the container is lowered, said container is pre-disposed towards sliding onto the support frame 910 once it contacts the guiding rails 925.

The plurality of magazines 915 is enclosed within an enclosure 930 as shown. The enclosure 930 has two pairs of openings 980 (top openings) and 981 (bottom openings) on opposite sides of the enclosure 930. The bottom set of openings is situated below those of where the magazines 916 and 917 are located. This is because in a further embodiment, the plurality of magazines 915 may be stacked above a second plurality (not shown) to provide the maximum available IBCs during installation and removal. The second plurality then dispenses or receives IBCs from the bottom set of openings 981 when the magazines are in the respective dispensing and receiving positions.

The embodiment of FIG. 9 is advantageous as multiple dispensing and receiving positions can also facilitate the usage of different IBCs as well as allow for a greater number of IBCs to be dispensed. Then again, it is not necessary to differentiate IBC types by magazine links or even by magazines. That is, under deck IBCs, differentiated from on deck IBCs, can be stored in magazines within the same collection or even within the same magazine if there is a memory (or counting) system associated with the entire system.

FIG. 10A shows one embodiment of an IBC installation and removal mechanism 1000 coupled to the fine alignment mechanism (not shown) suitable for handling the IBC as shown in FIGS. 2A and 2C. With respective modifications (which are known to the skilled person) the system can handle IBCs as depicted in FIG. 2B. The IBC installation and removal mechanism includes lever actuator 1015 that is pivotally mounted about a pivot. The lever actuator 1015 is U-shaped ends perpendicular to the rest of the rod and is adapted to manipulate the IBCs of FIGS. 2A and 2C respectively.

In addition to the IBC installation and removal mechanism, the FIG. 10A illustrates an IBC ejector and retrieval mechanism as well. Said mechanism primarily comprises of a piston 1030 and a ram 1020. The piston is adapted to translate along the central axis of the elongated magazine to dispense IBCs to the IBC installation and removal device. The piston 1030 is mounted with its longitudinal axis aligned parallel with that of the magazine(s). In the IBC dispensing/receiving position, the longitudinal axis of the piston 1030, as mentioned previously is aligned with that of the magazine (i.e. along the central axis of the circular magazine, for example). The incremental movement of the piston 1030 is selected or adjusted to correspond with the length of the IBC when stored in a magazine. Accordingly, each incremental movement forward results in the IBC being dispensed for the IBC installation and removal device to carry out installation operations, for example.

During the IBC installation and IBC removal process, the IBC installation and removal device may be actuated by hydraulic means 1025. The hydraulic means 1025 is driven along a cam profile 1028 such that the resulting motion of the entire arm, during the installation process, provides for the fitting of the IBC into the corresponding corner fitting of the container.

During IBC retrieval operations, the lever actuator 1015 when actuated via the hydraulic means 1025, for example, removes the IBC from the respective corner fitting and the IBC removed thereby is deposited in alignment with the magazine opening (not shown), after vertically downward translation by the relevant mechanism. The ram 1020 then moves co-axially to the magazine or along the central axis of the magazine to push the retrieved IBC back into the magazine.

The entire IBC installation and removal device mechanism 1000 is situated on the alignment mechanism of FIG. 11. The guiding elements 1010 are adjacent to the IBC installation and removal device mechanism 1000. This allows the IBC installation and removal mechanism 1000, especially the lever actuator 1015 to be suitably aligned with the corner fitting as a precise alignment of said lever actuator 1015 to the corner fitting is beneficial to the operation of the present invention.

In FIG. 10B a robotic arm for attaching (clasping for installation or removal purposes) is shown. FIG. 10B(A-1) shows the clasping profile 1060 and the arm 1065 to which it is attached, prior to engaging the IBC 200 that is dispensed from the magazine (not shown). The clasping arm 1065 is hinged at pivot point 1055 to a portion 1050. The portion 1050 is attached to a larger servo-mechanism (not shown) that is capable of providing, to the entire arm 1065, three sequential movements. In the illustration, the arm 1065 is shown to be moveable rotationally about the origin between x and y, dragged along z, and rotated about the origin between y and z. FIG. 12B(B-1) shows the engagement of the arm 1065 and clasping profile 1060 with the IBC 200.

FIG. 10C shows how another embodiment of an IBC installation and removal mechanism engages an IBC 200 during the removal process. The arm 1060 will engage with the IBC 200. Subsequently, a catch 1080 is depressed downwards in the z-axis to disengage the IBC lever, as shown in FIG. 10C(B-1). The entire mechanism (including IBC) is then rotated at about 38 degrees, for example, clockwise, as shown in FIG. 10C(C-1). The arm 1060 then moves downwards in the z axis to fully release the IBC 200 from the corner fitting of the container, as shown in FIG. 10C(D-1).

FIG. 10D illustrates an enlargement 1500 of another embodiment of a fine alignment mechanism showing the insertion of an IBC 200 into a corner fitting by means of an IBC installation and removal mechanism 1540. The guiding elements 1520 are shown to be engaged with the corners of the container, as described in FIG. 13 below. The IBC installation and removal device includes arc-like slots 1530 in which the member 1540 slides during the installation or removal process. The slots 1530 direct the member to move in a specific motion such that the engaged IBC 200 is inserted and secured within the corner fitting 1510 of the container.

FIG. 10E illustrates a further embodiment 2000 of the IBC installation and removal mechanism. In this embodiment 2000, the fine alignment mechanism 2030 is used as is described below in FIG. 17. The fine alignment mechanism aligns the container 2 with the magazines held by the transport mechanism (silos) 2080. When the corner fitting of the container 2005 is aligned with the magazines held in the transport mechanism 2080, a jacking mechanism (not shown) lifts the magazine 2090 in alignment with the respective corner fitting 2005 to the said corner fitting 2005. The jacking mechanism causes the magazine 2090, which has the IBCs 200, positioned therein, to actively engage the corner fitting 2005. The engagement results in the installation of the IBC 200 to the said corner fitting 2005. The process may be repeated for subsequent containers till all the IBCs in said magazine 2090 are dispensed. The transport mechanism 2080 then rotates a fresh magazine 2090 into place to resume the IBC installation operation. Conversely, during IBC removal operations, the magazine 2090 receiving the IBCs is placed in alignment with the corner fitting of the container 2. When the magazine is raised to meet the corner fitting 2005 having an IBC, the magazine is adapted such that is performs the IBC removal process and retrieves the IBC from said corner fitting.

The embodiment of FIG. 10F is essentially similar to the embodiment of FIG. 10E with the exception that the magazine 2025 is shaped (adapted) to manipulate the magazine during the jacking up sequence mentioned above, to carry out IBC installation and removal operations. Accordingly, the magazine may also be of any other shape and may have suitable guiding means within said magazine to allow for an IBC to be rotated or translated vertically, horizontally or diagonally to be securely fitted to the respective corner fittings.

FIG. 11 is an illustration of an IBC installation and removal alignment mechanism (fine alignment mechanism) 1100. IBC installation and removal devices are not shown for sake of clarity. The entire mechanism 1100 is supported by the base 1 and coupled to the supporting frame (not shown). The mechanism 1100 includes a floating frame 1120 being x-shaped. Alternatively, in place of an x-shaped frame (x-frame), an elastically coupled I-frame or any other elastically coupled frame such as a regular rectangular shaped frame may also be used, for example. The x-frame 1120 is coupled to the supporting frame via elastic means (not shown) such that the x-frame 1120, in its default state is biased towards remaining in the centre relative to the base 1. The x-frame 1120 may also be vertically moveable and has vertical guides 1130 to direct the upward or downward motion. Accordingly, the x-frame 1120 may only move freely within its given horizontal plane while the vertical movement of the IBC installation and removal arm alignment mechanism 1110 may be controlled by other mechanisms such as hydraulic, electrical or pneumatic means, for example. Portions 1180 and 1190 of the alignment mechanism correspond to two twenty-foot IBC storage and handling systems in a collinear arrangement.

The alignment mechanism 1100 also includes guiding arms 1110 located symmetrically around the vertically moveable portion of the mechanism 1100. The guiding arms 1110 perform the function of engaging the container when raised vertically upwards. The guiding arms engage the container by first abutting against the respective sidewalls of said container and then sliding against them. Should the container be not aligned directly above the alignment mechanism 1100, as the guiding arms 1010 engage the container, the elastically coupled frame (x-frame, I-frame or regular rectangular frame) translates, as mentioned above, within its own horizontal plane such that the frame (x-frame, I-frame or regular rectangular frame), and any fixtures mounted thereon, such as the IBC installation and removal mechanism, for example, are aligned to the respective corner fittings of the container.

Once aligned to the container, in the example of the embodiment having an IBC installation and removal mechanism as described in the embodiments of FIGS. 10A-10E, the IBC installation and removal mechanism is also aligned with the respective corner fittings of the freight container to carry out either the installation or removal of the IBCs from said corner fittings.

FIG. 12 illustrates a plurality of magazines 1315 and the arrangement of IBCs 200 therein. FIG. 12 also shows a sectional view of the magazines 1316 and the arrangement of IBCs 200 within said magazines. The IBCs 200 are arranged in a continuous linear arrangement with the opening of the supplying/receiving magazine 1350 oriented to be proximate to the corner fitting of the container (not shown). Accordingly, the IBCs are dispensed (or received) through the opening 1350 during IBC installation and removal operations respectively. During the supplying/receiving process the IBCs 200 are dispensed through the opening 1350 by the ram and piston mechanism of FIG. 12. The IBC installation and removal mechanism of FIG. 12 engages said IBCs 200. The guiding elements 1320, working in conjunction with the fine alignment mechanism of FIG. 11 ensures that the IBC installation and removal mechanism (not shown), and the IBC engaged thereto, are sufficiently aligned with the corner fitting of the container.

FIGS. 13A and 13B show an enlargement 1400, principally of the guiding elements 1420 of the fine alignment mechanism when engaged with a container. The guiding elements 1420 engage the corners of the container at right angles such that the respective corner fittings of the container 1410 are aligned with the IBC installation and removal device 1440. As described in FIG. 12, once the IBC installation and removal device 1440 engages the IBC 200, and the alignment of the IBC installation and removal device 1440 to the respective corner fitting 1410 is subsequently achieved by the said means of the guiding elements, the IBC installation and removal device 1440 proceeds to install the IBC 200 into said corner fitting.

FIG. 14 illustrates a further embodiment of the fine alignment mechanism. In FIG. 14A, the container 2 rests upon the platform 2350. The platform is depressed and the container begins to contact the guiding arm 2305. The guiding arm 2305 is slidably mounted along slot 2310 and pivoted at point 2315. FIG. 14B shows the container fully settled onto the platform 2350. The engagement of the container 2 to the guiding arm 2305 causes the guiding arm 2305 to pivot about the pivotal point 2315 and slide along the slot 2310 to fully engage the walls of the container 2.

FIG. 15 is an isometric drawing of a further embodiment of the IBC storage and handling system. The container 2 is placed on the depressible platform 1690. The platform 1690 is mechanically engaged to both the fine alignment mechanism 1625 and the IBC handling (installation and removal) mechanism 1650. The IBC handling mechanism is proximate to the magazine 1680. It should be noted that only one magazine 1680 is shown to provide more clarity to the illustration. However, it is to be understood that a plurality of magazines may be arranged as previously described.

FIG. 16 illustrates an alternative embodiment of a fine alignment and IBC installation and removal mechanism. The embodiment 1700 of the present invention leverages on the weight of the container to actuate the fine alignment mechanism (that includes guiding arms 1705) and to further actuate the installation and removal mechanism 1770. The container (not shown), during IBC installation operations for example, is placed on the support platform 1750.

The support platform 1750 is mechanically engaged, in a depressible manner, to the fine alignment and IBC installation and removal mechanisms via rack and pinion gears 1725 and 1730. The support platform 1750 is engaged to the fine alignment mechanism in a similar manner as well. When the container is placed on top support platform 1750, the weight of the container pushes the support platform 1750 downwards. Said downward movement of the support platform 1750 actuates the fine alignment mechanism to clasp the container through horizontal sliding movements of the arms 1705. The arms 1705 move in a slidable manner through the collar 1706 to clasp both the longitudinal and latitudinal dimensions of the container.

As the depressible support platform 1750 is also mechanically engaged to the IBC installation and removal mechanism, the IBC installation and removal mechanism is simultaneously translating upwards towards the corner fittings of the container. As the fine alignment mechanism secures itself to the container, the IBC installation and removal arm, having already received the IBC from the magazine 1780, is proximate to the respective corner fittings of the container.

The IBC installation and removal mechanism is similar to that as described in FIG. 12. The IBC, when received from the magazine 1780 is held by the IBC installation and removal device 1770, which has been described in FIG. 15. As the arms 1705 of the fine alignment mechanism clasp the container, the IBC installation and removal device engages the respective corner fittings and installs the IBC during the installation operation accordingly.

Conversely, in the case of IBC removal operations, a container with IBCs installed is placed onto the support platform 1750 and the same sequence of movements occur with respect to the fine alignment and IBC installation and removal mechanisms. However, in this regard, the IBC installation and removal mechanism does not receive an IBC from the magazine 1780. Instead, as it engages the corner fitting, the IBC installation and removal device (not shown) removes the IBC and returns it to the receiving magazine 1780 subsequently.

FIG. 17 illustrates the mechanism of the fine alignment mechanism and the IBC installation and removal mechanism of FIG. 15. In FIG. 17, the fine alignment mechanism is not necessarily elastically coupled to the support frame, unlike the previous embodiment of FIG. 11. Rather, the fine alignment mechanism shown is coupled to the depressible support platform (or surface) 1850 such that when the container is placed onto said platform (or surface) 1850, the weight of said container causes the guiding arms 1805 of the alignment mechanism to engage the respective walls of the container.

The guiding arms 1805 are connected to the depressible platform 1850 via a rack and pinion gear mechanism. In this regard, as the platform 1850 moves downwards from the weight of the container, the pinion gears 1836 (coupled to the guiding arms) engaged to the rack gear 1835 rotate in a manner that causes the guiding arms 1805 to be moved in a slidable manner, via collars 1806, to engage the walls of the container. This movement occurs as the rack gear 1835 moves downwards along under the weight of the container.

The coupling of the depressible platform to the IBC handling mechanism (IBC installation and removal mechanism) is achieved by a rack and pinion gear arrangement similar to that as described above. In this regard, the downward movement of the rack gear 1835, as previously mentioned, also causes the upward movement of the handling mechanism 1870 and arms towards the corner fittings of the container. The upward movement of the handling mechanism 1870 results from the rotation of pinion gear 1830 in the anti-clockwise direction. It follows that the corresponding pinion gear 1831 rotates in the clockwise direction. The resulting motion directs the other set of rack gears 1825 and 1826 to move upwards thereby allowing the handling mechanism 1870 to fit or remove the IBC from the respective corner fittings.

FIG. 18 further illustrates the mechanism of the IBC installation and removal mechanism of FIG. 15. The two shafts 1990 are linked to the respective guiding arms 1905 of the fine alignment mechanism such that when actuated, the arms translate to engage the container. Simultaneously, the IBC handling mechanism 1970 is aligned with and moving towards the respective corner fittings. In IBC installation operations, the handling mechanism may receive an IBC 200 from the magazine 1980 prior to being translated towards the corner fitting.

FIG. 19 illustrates an embodiment by which the magazines 2050 are linked when placed in a vertical orientation as shown in FIG. 10E. The linkages 2102 are placed on alternate sides of a pair of magazines.

FIG. 20 shows another embodiment by which the magazines 2050 are linked when placed in a vertical orientation as shown in FIG. 20. In this particular embodiment, the linkage 2202 is linear and in between each magazine 2050.

FIG. 21 shows part of a corner of the IBC installation and removal system. As described above, said system includes a plurality of magazines and is moveable (either in a vertical or horizontal arrangement) on a cyclic conveyor system 2600. The cyclic conveyor system 2600 comprises two parallel rails 2610 that run perpendicular to the central axes of each magazine 2650. The rails 2610 are formed with gear teeth on the inner surface of said rails. Each magazine has corresponding gear teeth 2620 formed on the circumference thereof such that the magazine is operatively engaged to the rails. In addition, each magazine 2650 is interdependently linked via a circular bracket 2670 to its adjacent magazine.

However, it should be noted that each magazine 2650 is freely oscillating under the effect of gravity, as the circular bracket 2670 does not fix the orientation of the magazine. Instead, the magazine orientation is dependent upon the direction through which the weight of the magazine (loaded or unloaded) acts.

The magazine is designed such that the IBCs loaded therein are also orientated such that the weight of the IBCs acts in a vertically downward direction at all times. This is achieved by having groves and slots 2660 within the magazine 2650 that are adapted to hold the IBC in such an orientation that the above-mentioned orientation of the magazine 2650 is achieved. To ensure that the desired orientation is maintained, each magazine has the groves and slots 2660 such that the centre of gravity (CG) of each magazine 2650 is below the centre of rotation of the circular bracket 2670. The centre of gravity (CG) of the magazine 2650 when loaded with IBCs remains below the centre of rotation of the circular bracket 2670. In an exemplary embodiment, in order for each magazine 2650 to self-adjust via gravitational effects, each circular bracket 2670 may include an internal frictionless bearing, for example.

When each magazine enters the dispensing position, for example, a ram 2680 engages either one end of said magazine or the midpoint of said magazine. The ram 2680 then slides toward an opening located at an end of the elongated magazine in incremental steps. Each incremental step pushes an IBC out of the magazine and into the installation and removal mechanism ready to be inserted into a corner fitting of a container during IBC installation operations:

Alternative drive mechanisms may be in the form of a timing belt to guide the outer rail, as shown in FIG. 21. In such an embodiment, a linear actuator may operate with a stroke length such that the magazine 2650 is indexed into and out of the IBC dispensing and receiving positions during each operation of the linear actuator. In any case, either clockwise or anti-clockwise rotation of the magazines 2650 may be permitted.

While a few embodiments of the IBC installation and removal apparatus have been described and illustrated, it is to be understood that many changes, modifications and variations may be made to the present invention without departing from the principle and scope of said invention.

1. An inter-box connector (IBC) storage and handling (installation and removal) system for a freight container having four bottom corner fittings, with each corner fitting being capable of receiving an IBC, the system comprising:
an IBC handling device comprising:
at least one elongated magazine, wherein the magazine has an opening at least one end thereof and being adapted for receiving and supplying IBCs through said opening;
a transport mechanism adapted to move the magazine into IBC receiving and supplying positions such that in each of said positions the opening of the magazine is proximate to one of the respective corner fittings; and
at least one IBC installation and removal mechanism arranged and adapted to receive IBCs supplied from the magazine through said opening and to install the same into the respective corner fitting in each of said positions, and to remove the IBCs from the respective corner fittings and supply the same into the magazine through said opening in each of said positions.

2. The system according to claim 1 further comprising a support structure having a supporting surface for supporting the freight container during installation or removal of IBCs into and from said bottom corner fittings respectively.

3. The system according to claim 1, having said IBC handling device coupled to the support structure underneath the support surface.

4. The system according to claim 2, wherein the magazine is horizontally orientated with respect to the supporting surface of the support structure and has an opening at one end thereof.

5. The system according to claim 2, wherein the magazine is vertically orientated with respect to the supporting surface of the support structure and has an opening at one end thereof.

6. The system according to claim 1, wherein the transport mechanism is adapted to move the magazine into four receiving and supplying positions.

7. The system according to claim 2, wherein the magazine is horizontally orientated with respect to the supporting surface of the support structure and has two openings at either end thereof, and the transport mechanism is adapted to move the magazine into two receiving and supplying positions.

8. The system according to claim 7, wherein the horizontally orientated magazine comprises two portions, each portion having two openings and being adapted for receiving and supplying IBCs from and to the respective corner fittings of the freight container.

9. The system according to claim 1, wherein the transport mechanism is adapted to move the at least one IBC installation and removal mechanism between any of the respective corner fittings of the freight container.

10. The system according to claim 1, wherein the transport mechanism is adapted to move the magazine into any of the said receiving and supplying positions by rotational or cyclic motion.

11. The system according to claim 10, wherein the transport mechanism is a cyclic conveyor mechanism capable of moving a plurality of magazines into said receiving and supplying positions by cyclic motion.

12. The system according to claim 1, wherein the IBC handling device comprises a plurality of magazines.

13. The system according to claim 1, wherein the IBC handling device comprises at least two transport mechanisms being arranged in a stack.

14. The system according to claim 1 further comprising an IBC installation and removal mechanism alignment mechanism.

15. The system according to claim 14, wherein the IBC installation and removal mechanism alignment mechanism comprises:
a horizontally moveable frame having four edges coupled to the support structure beneath the support surface via elastic means,
at least one vertically moveable arm coupled to said horizontally moveable frame,
four IBC installation and removal mechanisms mounted on said at least one vertically moveable arm in alignment with the respective corner fittings, wherein the vertically moveable arm is moveable between an initial position and a final position, such that the initial position allows each of the IBC installation and removal mechanisms to receive and supply IBCs from and to the magazine, and the final position allows each of the IBC installation and removal mechanisms to install and remove IBCs in and from the corner fittings respectively; and
at least four guiding elements wherein each guiding element extends vertically upwards from each of the four edges of the horizontally moveable frame and is adapted to engage the container by first abutting, and then sliding on the respective walls of the container during motion between said initial and final position.

16. The system according to claim 15, wherein the IBC installation and removal mechanism alignment mechanism comprises four pairs of guiding elements, wherein each pair extends vertically upwards from each of the four edges of the frame and is adapted to engage the container by first abutting, and then sliding on the respective walls of the container during motion between said initial and final position.

17. The system according to claim 15, wherein the elastic means is a compression/torsion spring, a cantilever or a monolithic flexural spring.

18. The system according to claim 2, wherein the supporting surface and/or the support structure for supporting the freight container during installation or removal of IBCs into and from said bottom corner castings is mechanically coupled to actuate the installation and removal mechanism and the fine alignment mechanism either sequentially or concurrently.

19. The system according to claim 1, wherein one of the at least one magazine is adapted to store a first variant of IBC and a second of the at least one magazine is adapted to store a second variant of IBC.

20. The system according to claim 2, wherein said support surface is dimensioned to correspond to the bottom dimensions of a freight container, and comprises an incline plane along at least two orthogonal dimensions corresponding to the bottom of the freight container.

21. The system according to claim 20, wherein said support surface comprises an incline plane along three or four orthogonal dimensions corresponding to the bottom of the freight container.

22. The system according to claim 1, wherein the IBC storage and distribution system further comprises an IBC transfer means, said IBC transfer means comprising:
a piston, and
a ram both being adapted to engage the magazine such that said piston and ram are slidable along the longitudinal axis of the magazine either towards or away from the corner fitting when said magazine is in the receiving and supplying position.

23. The system according to claim 1, wherein the IBC installation and removal mechanism is actuated by hydraulic means, pneumatic means or electromechanical means.

24. The system according to claim 1, wherein the IBC installation and removal mechanism comprises:
a clasping portion adapted to clasp an IBC, and
an actuating portion,
wherein said clasping portion is situated atop the actuating portion, said actuating portion having a slot profile such that movement in a first direction along the slot profile by the installation and removal mechanism installs the IBC into the corner fitting and a movement in a second direction along the slot profile removes the IBC from the corner fitting.

25. A system for the installation and removal of inter-box connectors (IBCs) for a freight container having four bottom corner fittings, with each corner fitting being capable of receiving an IBC, the system comprising:
at least two IBC handling devices as defined in claim 1 being arranged in a collinear relationship and adapted to receive at least one 40 foot long freight container.

26. A system for the installation and removal of inter-box connectors (IBCs) for a freight container having four bottom corner fittings, with each corner fitting being capable of receiving an IBC, the system comprising:
a quay crane, and
an inter-box connector (IBC) installation and removal system for the freight container, the system comprising:
an IBC handling device comprising:
at least one elongated magazine, wherein the magazine has an opening at least one end thereof and being adapted for receiving and supplying IBCs through said opening;
a transport mechanism adapted to move the magazine into IBC receiving and supplying positions such that in each of said positions the opening of the magazine is proximate to one of the respective corner fittings; and
at least one IBC installation and removal mechanism arranged and adapted to receive IBCs supplied from the magazine through said opening and to install the same into the respective corner fitting in each of said positions, and to remove the IBCs from the respective corner fittings and supply the same into the magazine through said opening in each of said positions.

27. An inter-box connector (IBC) magazine comprising:
an elongated hollow shaft having an opening at least one end thereof, said hollow shaft being adapted for receiving and supplying IBCs through said opening.

28. The IBC magazine of claim 27, wherein the IBC magazine is adapted to move between IBC receiving and supplying positions by a transport mechanism such that in each of said positions the opening of the magazine is proximate to one of the respective corner fittings.

29. The IBC magazine of claim 27, wherein the IBC magazine is adapted to supply and receive IBCs during the installation and removal of IBCs from the respective corner fittings.
